(19) United States
(12) Patent Application Publication
(10) Pub. No.: US 2015/0129074 A1
(43) Pub. Date: May 14, 2015

(54) TUBULAR KNITTED LINER

(71) Applicant: Johann KÜBEL, Kasten (AT)

(72) Inventor: Johann Kuebel, Kasten (AT)

(21) Appl. No.: 14/415,225

(22) PCT Filed: Jul. 16, 2013
(86) PCT No.: PCT/AT2013/050136

§ 371 Date: Jan. 16, 2015

(30) Foreign Application Priority Data
Jul. 16, 2012 (AT) A 791/2012

(51) Int. Cl. F16L 55/165; D06M 15/21; D06M 15/507

(52) U.S. Cl. CPC F16L 55/1656; D06M 15/507; D06M 15/21
USPC 138/98; 428/64.1; 428/34.5

(57) ABSTRACT

A liner or prepreg for installation in pipelines includes a deformable circular knitted fabric impregnated with synthetic resin, which is preferably UV-curable.

The invention relates to a liner or a prepreg for installation in pipelines.

Such liners are used for lining pipelines for drinking water, sewage, etc., if the pipelines have been leaking or should be rehabilitated as a precaution, in order to prevent leaks. Such liners are applied or pressed onto the inner wall of the pipeline and cured in situ, particularly by irradiation with UV light.

Such liners exist advantageously in the form of so-called prepregs. Covered with plastic films, prepregs exist in the form of synthetic resin impregnated fiber structures, particularly flat structures, and can be kept in storage over extended periods of time. The resin-wet and deformable prepregs are then introduced as liners into the pipelines, applied there and cured.

The liners should be easily deformable, adaptable precisely to the inner walls of the piping and inexpensive to admit. Furthermore, the liners should be easily curable and possess appropriate strength in the cured state. Lifting of the liner or of the prepreg used in the course of its installation on the inner wall of the piping or during the curing and also afterwards should be excluded. A liner should be easily and rapidly producible and a cured liner located in a pipeline must adhere tightly to the pipeline, possess a substantial service life, and be resistant to wear and tear.

These objectives are achieved in a liner of the type mentioned at the outset in that the liner or the prepreg comprises a deformable circular knitted fabric impregnated with preferably UV-curable synthetic resin. A circular knitted fabric is easily deformable and receives the synthetic resin without dripping or leakage. Furthermore, a circular knitted fabric possesses the best strength properties and can be easily produced. The properties mentioned are further improved if the tubular circular knitted fabric is created with multi-threaded fiberglass yarn. Thus, the strength properties and the synthetic resin reception are improved. If the fiberglass yarn possesses a weight of 1000 to 1800 tex, preferably from 1200 to 1600 tex, and/or the surface weight of the circular knitted fabric formed with fiberglass yarn is 2500 to 6000 g/m², the curing properties as well as the installation are positively affected. Advantageously, the fiberglass percentage of the total weight of the circular knitted fabric impregnated with synthetic resin is 20 to 30%, preferably 20 to 27%. Thus, the curing behavior is improved and a leakage of synthetic resin prevented.

A liner or a prepreg according to the present invention can be produced in a simple manner by circular knitting of fiberglass yarns and impregnation of the circular knitted fabric or of the tube obtained with synthetic resin. The circular knitting takes place by means of conventional circular knitting machines, with which fiberglass yarns are enmeshed. The knitting occurs in the conventional manner with known mesh structure. Due to its mesh structure, the circular knitted fabric obtained or the circularly knitted tube obtained is expandable in all directions of the plane and can be brought into a desired form easily or through special exertion of force. The fiberglass yarns used possess great strength and bending properties. It is useful for practice, if the fiberglass yarns possess a weight from 1000 to 1800 tex. Thus, sufficient strength is also achieved in the case of small quantities of resin. The provided surface weight of the fiberglass circular knitted fabric also contributes to this end.

A balanced relationship of the materials used, namely of fiberglass and synthetic resin, results in optimal strength, deformability, bending properties and durability particularly when the fiberglass percentage of the total weight of the circular knitted fabric impregnated with synthetic resin is 20 to 30%, preferably 25 to 27%. When the liner is used, the synthetic resin remains in the knitted fabric, which can be applied to the surface to be covered in a very deformable manner.

It is readily possible to form the individual fiberglass yarns with a multiplicity of glass threads. It is preferably provided, if a fiberglass yarn is formed with 1500 to 3500 threads.

In an advantageous manner, polyester resins or vinyl ester resins are used as UV-curable synthetic materials.

In the case of a pipeline, which is lined with a liner according to the present invention on its inner wall surface, an exact fit and a good adhesion of the liner to the inner wall surface of the pipeline are achieved, so that leaks are prevented or eliminated and at the same time the wall structure is reinforced and the wall strength improved.

A circular knitted fabric liner used advantageously in practice was created with a surface weight of 4000 g/m². The circular knitted fabric was created with a fiberglass yarn with 1200 tex. The fiberglass yarn of the circular knitted fabric comprised 1200 threads. The fiberglass percentage of the total weight of the impregnated circular knitted fabric, that is, of the weight of the fiberglass and of the synthetic resin, was 26%. The circular knitted fabric was impregnated with polyester resin and the curing of the liner created according to the present invention was carried out by means of UV light, wherein UV-emitters were introduced into the interior of the tubular liner situated in the pipeline and adapted to the inner wall of the pipeline.

1-10. (canceled)

11. A liner or prepreg for installation in pipelines, comprising a deformable circular knitted fabric impregnated with a synthetic resin.

12. The liner or prepreg according to claim 11, wherein said synthetic resin is a UV-curable resin.

13. The liner or prepreg according to claim 11, wherein said knitted fabric is a tubular knitted fabric formed with multi-threaded fiberglass yarn.

14. The liner or prepreg according to claim 13, wherein said fiberglass yarn has a weight from 1000 to 1800 tex.

15. The liner or prepreg according to claim 14, wherein the weight of said fiberglass yarn lies between 1200 and 1600 tex.

16. The liner or prepreg according to claim 13, wherein a surface weight of said circular knitted fabric formed with fiberglass yarn is between 2500 and 6000 g/m².

17. The liner or prepreg according to claim 11, wherein a percentage of said fiberglass in said circular knitted fabric impregnated with said synthetic resin lies between 20 and 30%.

18. The liner or prepreg according to claim 17, wherein the percentage of said fiberglass in said circular knitted fabric impregnated with said synthetic resin lies between 20 and 27%.

19. The liner or prepreg according to claim 13, wherein said fiberglass yarn is formed with 1500 to 3500 glass threads.

20. The liner or prepreg according to claim 11, wherein said synthetic resin is a polyester resin or a vinyl ester resin.

21. A pipeline, comprising a pipeline wall with an inner wall surface and a liner or prepreg according to claims 11 disposed on said inner wall surface.

22. The pipeline according to claim 21, wherein said liner or prepreg according to claim 11 is applied and/or fastened on said inner wall surface of said pipeline wall and said synthetic resin is cured together with the circular knitted fabric embedded in the synthetic resin, which is adapted to a form of said inner wall of the pipeline.

23. The pipeline according to claim 21, wherein a weight of the circular knitted fabric in the cured liner formed with fiberglass yarn possesses a percentage of a total weight of the cured liner from 20 to 30%.

24. The pipeline according to claim 23, wherein the weight of the circular knitted fabric in the cured liner amounts to a percentage of a total weight of the cured liner from 23 to 27%.
